(19) United States
(12) Patent Application Publication
(10) Pub. No.: US 2017/0273341 A1
(43) Pub. Date: Sep. 28, 2017

(54) Flavor Enhancement System

(71) Applicant: Inspired Technologies, Inc., Le Sueur, MN (US)

(72) Inventor: Luke Logan Wagner, Le Sueur, MN (US)

(73) Assignee: Inspired Technologies, Inc., Le Sueur, MN (US)

(21) Appl. No.: 15/465,037

(22) Filed: Mar. 21, 2017

Related U.S. Application Data
(60) Provisional application No. 62/311,541, filed on Mar. 22, 2016.

(51) Int. Cl. A23L 27/20; A23L 27/14; A23L 27/12; A23L 27/00

(52) U.S. Cl. CPC A23L 27/20; A23L 27/80; A23L 27/14; A23L 27/12; A23L 27/13; A23V 2002/00

(57) ABSTRACT

The disclosure provides a system for enhancing the flavor of a consumable.

### CROSS-REFERENCE TO RELATED APPLICATIONS

This application claims the benefit of U.S. Provisional Patent Application No. 62/311,541 filed Mar. 22, 2016, which is hereby incorporated by reference in its entirety.

### STATEMENT REGARDING FEDERALLY SPONSORED RESEARCH OR DEVELOPMENT

Not applicable.

### TECHNICAL FIELD

The instant disclosure relates to flavor enhancements systems. More particularly, the disclosure pertains to enhancing the flavor of a consumable such as, for example, a beverage.

### BACKGROUND

It has been known that certain beverages have an enhanced flavor derived from the person first tasting salt and/or citrus flavors, thus cleansing the taste buds before drinking the beverage.

Bars generally provide a slice of an orange or lime or lemon alongside certain drinks. The salt placed upon the edges of a Margarita drink and a lime slice mounted on the edge of the glass, for example, are a trademark of that particular drink.

Certain beers are traditionally served with a lemon or lime slice and a salt shaker to enable the patron a way to taste the citrus flavor and salt before drinking the beverage. Salt is commonly placed on the back of the hand and licked while the lemon or lime may either be licked off the outer surface of a bottle or glass or squeezed into the beer.

Various devices, systems and methods have been developed that dose the entire drink with salt and citrus, coat the inside of the container or mechanically apply a coating of salt powder alone or a combination of flavors on the rim of a bottle or glass.

### SUMMARY

A non-limiting exemplary embodiment of a system for enhancing the flavor of a consumable includes a label having opposing first and second surfaces, a flavoring substance disposed on at least a portion of the first surface, a first pull-tab removably affixed to the first surface of the label and covering the flavoring substance in its entirety, and an adhesive on at least a portion of the second surface.

Another non-limiting exemplary embodiment of a system for enhancing the flavor of a consumable includes an adhesive disposed on at least a portion of an outside surface of a container of the consumable, a flavoring substance disposed on at least a portion of the adhesive, and a pull-tab removably affixed to the outside surface of the container and covering the flavoring substance in its entirety.

Yet another non-limiting exemplary embodiment of a system for enhancing the flavor of a consumable includes an emulsion disposed on at least a portion of an outside surface of a container of the consumable, and a pull-tab removably affixed to the outside surface of the container and covering the emulsion in its entirety.

### BRIEF DESCRIPTION OF THE DRAWINGS

FIG. 1A is a plan view of a non-limiting exemplary embodiment of a label having a flavoring substance disposed thereon;

FIG. 1B is a perspective view of the label of FIG. 1A configured for use;

FIG. 1C is a plan view of a non-limiting exemplary embodiment of a pull-tab for use with the label of FIG. 1B;

FIG. 1D is a perspective view of the pull-tab of FIG. 1C configured for use;

FIG. 2A is a perspective view of a non-limiting exemplary embodiment of a container of a flavoring substance having the label of FIG. 1A disposed thereon;

FIG. 2B illustrates the container of FIG. 2A having the pull-tab of FIG. 1C covering the flavoring substance disposed on the label;

FIG. 3A is a plan view of a non-limiting exemplary embodiment of another label having a flavoring substance disposed thereon;

FIG. 3B is a perspective view of a container of a flavoring substance with the label of FIG. 3A disposed thereon;

FIG. 3C is a plan view of a non-limiting exemplary embodiment of another pull-tab for use with the label of FIG. 3A;

FIG. 3D illustrates the container of FIG. 3B with the pull-tab of FIG. 3C;

FIG. 4A is an elevational view of a non-limiting exemplary embodiment of yet another label having a flavoring substance disposed thereon;

FIG. 4B is a perspective view of a container of a flavoring substance having the label of FIG. 4A disposed thereon;

FIG. 4C is an elevational view of a non-limiting exemplary embodiment of yet another pull-tab for use with the label of FIG. 4A;

FIG. 4D illustrates the container of FIG. 4B with the pull-tab of FIG. 4C;

FIG. 5A is a perspective view of a non-limiting exemplary embodiment of a container of a flavoring substance having a composition disposed on an exterior surface thereof;

FIG. 5B is an elevational view of a non-limiting exemplary embodiment of a pull-tab for covering the composition disposed on the container of FIG. 5A;

FIG. 5C is a perspective view of a non-limiting exemplary embodiment of a sleeve for covering the composition disposed on the container of FIG. 5A;

FIG. 5D illustrates the container of FIG. 5A having the sleeve of FIG. 5C covering the composition disposed on the container;

FIG. 6A is a perspective view of a non-limiting exemplary embodiment of a container of a flavoring substance having a composition disposed on an exterior surface thereof;

FIG. 6B illustrates a non-limiting exemplary embodiment of a sleeve for covering the composition disposed on the container of FIG. 6A;

FIG. 7A is a non-limiting exemplary embodiment of a novelty item having a flavoring system;

FIG. 7B illustrates the flavoring system included on the novelty item of FIG. 7A;

FIG. 7C illustrates a non-limiting exemplary embodiment of a confectionary item associated with an embodiment of the novelty item;

FIG. 7D illustrates a non-limiting exemplary embodiment of a step in a method of using the flavoring system of FIG. 7B and the confectionary item of FIG. 7C;

FIG. 8 is another non-limiting exemplary embodiment of a step in a method of using the flavor enhancement system of the instant disclosure; and

FIG. 9 illustrates non-limiting exemplary embodiments of labels having flavoring substance for an exemplary festival.

### DETAILED DESCRIPTION

One or more non-limiting embodiments are described herein with reference to the accompanying drawings, wherein like elements are designated by like numerals. It should be clearly understood that there is no intent, implied or otherwise, to limit the disclosure in any way, shape or form to the illustrated and described embodiments. While multiple exemplary embodiments are described, variations thereof will become apparent or obvious. Accordingly, any and all variants for providing functionalities similar to those of the described embodiments are considered as being within the metes and bounds of the instant disclosure.

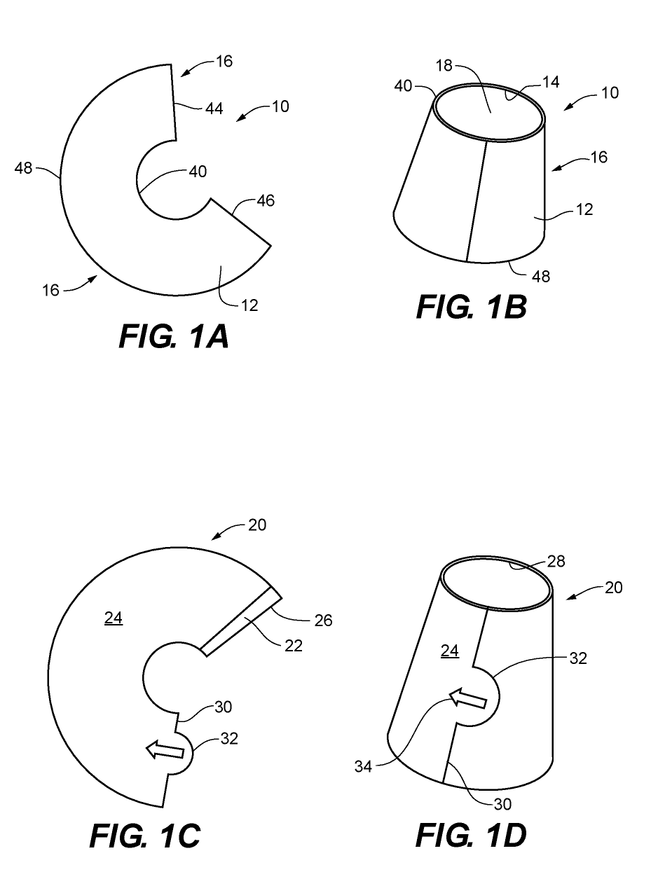

FIG. 1A is a plan view of a non-limiting exemplary embodiment of a label 10 having opposing first and second surfaces 12 and 14, respectively, and FIG. 1B is a perspective view of the label 10 configured for use. In some embodiments, the label 10 includes a flavoring substance 16 disposed on the first surface 12. While FIGS. 1A and 1B illustrate the flavoring substance 16 disposed on the entirety of first surface 12, it should be understood that this is not a requirement. As described elsewhere in the instant disclosure, the flavoring substance 16 can be disposed on a portion of the first surface 12. In certain embodiments, the label 10 includes an adhesive 18 disposed on the second surface 14. In some embodiments, the adhesive 18 may be disposed on the entirety of the second surface 14. In certain embodiments, the adhesive 18 may be disposed along the perimeter of the second surface 14.

FIG. 1C is a plan view of a non-limiting exemplary embodiment of a pull-tab 20 for use with the label 10, and FIG. 1D is a perspective view of the pull-tab 20 configured for use with the label 10. In some embodiments, the pull-tab 20 includes a tacky substance disposed on, for instance section 22, on a top surface 24 proximate an edge 26. Generally, the tacky section 22 is configured for removable engagement with at least a portion of a bottom surface 28 proximate an edge 30 of the pull-tab 20 when the pull-tab 20 is wrapped around as illustrated in FIG. 1D. The embodiment of the pull-tab 20 illustrated in FIGS. 1C and 1D should not be construed as limiting. While FIG. 1C illustrates the tacky section 22 disposed on the top surface 24 of the pull-tab 20, this is not a requirement. In certain embodiments, the tacky section may be disposed on the bottom surface 28 proximate the edge 30 for removable engagement with a portion of the top surface 24 proximate the edge 26. In some embodiments, the tacky section may be provided on both the top and the bottom surface 24 and 28 proximate respective edges 26 and 30 of the pull-tab 20.

In a non-limiting exemplary embodiment, the pull-tab 20 includes a tab 32 extending away from a portion of the edge 30. As best seen in FIG. 1D, the tab 32 is configured to overlap at least a portion of the top surface 24. In some embodiments, the overlap is advantageously used for removably engaging the top surface 24 and the tab 32 with each other. In some embodiments, when the tab 32 is displaced in the direction indicated by an arrow 34, the engaged portions proximate the edges 26 and 30 of the pull-tab 20 will dis-engage from each other. In certain embodiments, the tacky section 22 can be provided, additionally or in the alternative, on a portion of the top surface 24 that will overlap with the bottom 28 of the tab 32. Also additionally or in the alternative, the tacky section can be provided on the bottom surface of the tab 32. The tacky section can be provided, in addition to or in the alternative, on both the bottom surface 28 of the tab 32 and the top surface 24 whereat the two will overlap. In some embodiments of the pull-tab 20 wherein the top surface 24 and the tab 32 are removably engaged, it may not be necessary to provide any tacky section(s) on the surfaces of the pull-tab 20 proximate the edges 26 and 30.

In a non-limiting exemplary embodiment, the pull-tab 20 does not include the tab 32. Accordingly, in some embodiments, at least a portion of the pull-tab 20 along the edge 30 and the top surface 24 are not engaged with each other. At least a portion of the pull-tab 20 along the edge 30 is then grasped and displaced in the direction indicated by the arrow 34 whereby the label 10 and the pull-tab 20 are dis-engaged from each other.

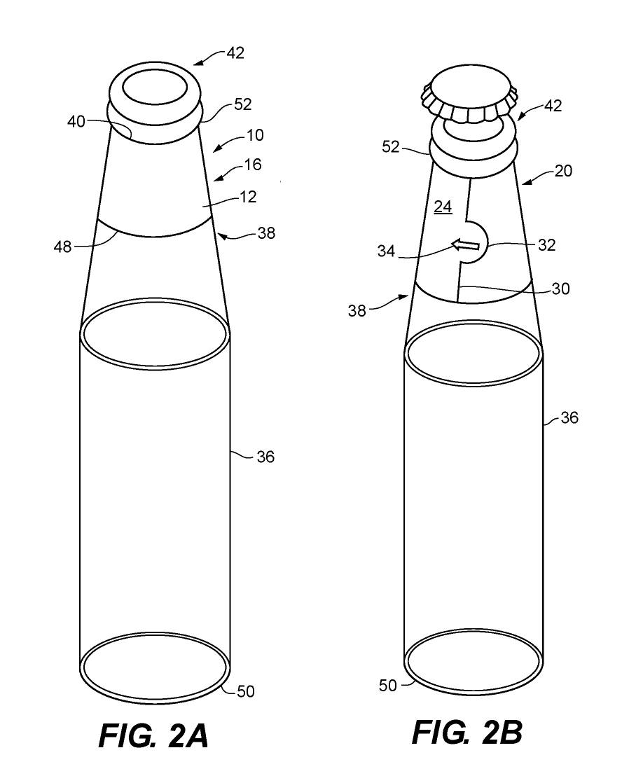

FIG. 2A illustrates a non-limiting exemplary embodiment of a container 36 having the label 10 disposed thereon with the flavoring substance 16 exposed. In some embodiments, the label 10 illustrated in FIG. 1A is wrapped around (as shown in FIG. 1B) a neck 38 of the container 36 with an edge 40 of the label 10 proximate an opening 42 of the container 36. In certain embodiments, the adhesive 18 on the second surface 14 will fixedly engage the label 10 and the container 36 to each other proximate the opening 42. In some embodiments, the label 10, additionally or in the alternative, includes overlap portions proximate each edge 44 and 46 configure for engaging each other such that the label 10 can be wrapped into the configuration illustrated in FIG. 1B around the neck 38. In certain embodiments, the label 10 is manufactured as a “sleeve” in the configuration shown in FIG. 1B. As such, the label 10 can be position on the neck 38 by displacing the opening 42 through the conical void of the label 10. In some such embodiments, the diameter of a perimeter 48 of the label 10 is configured to arrest further displacement of the label 10 towards a bottom 50 of the container 36 when the edge 40 of the label 10 is positioned proximate a top 52 of the neck 38. In certain embodiments, the label 10 is composed of a heat shrink material configured to engage the neck at the desired location. In some embodiments, the label 10 is composed of an elastic material whereby the conical void of the label 10 can be enlarged or stretched for positioning and engaging the label 10 with the neck 38. Accordingly, in certain embodiments, it may not be necessary to provide the adhesive 18 on the second surface 14 of the label 10. The disclosed configurations and/or functionalities of the label 10 should not be construed as limiting. Alternative and/or additional embodiments may become apparent to a person of ordinary skill. Accordingly, all variations are considered as being within the metes and bounds of the instant disclosure.

Once the label 10 has been positioned on the container 36 as shown in FIG. 2A, the pull-tab 20 is positioned to cover the entirety of the exposed flavoring substance 16 and then removably affixed to the label 10 as illustrated in FIG. 2B. The manner of configuring the pull-tab 20 to cover the flavoring substance 16 is described elsewhere with reference to FIGS. 1C and 1D.

In a non-limiting exemplary embodiment of a method of use, the user removes at least a portion of the pull-tab 20 to expose at least a portion of the flavoring substance 16 for consumption in combination with the contents of the container 36. In some embodiments, the user licks the flavoring substance 16 prior to consuming the contents of the container 36. In certain embodiments, the user licks the flavoring substance 16 after consuming the contents of the container 36. In some embodiments, the user concurrently consumes the flavoring substance 16 and the contents of the container 36 for instance by placing at least a portion of the neck 38 in the mouth and orienting the container 36 to dispense the contents thereof. In certain embodiments, the user concurrently consumes the flavoring substance 16 and the contents of the container 36 for instance by first placing at least a portion of the flavoring substance 16 around the neck 38 in a container, e.g., a glass, and then dispensing the contents of the container 36, thereby permitting interaction between the flavoring substance 16 and the contents of the container 36 prior to consumption. In some embodiments, the user concurrently consumes the flavoring substance 16 and the contents of the container 36 for instance by first dispensing the contents of the container 36 into a container, e.g., a glass, and then submerging at least a portion of the flavoring substance 16 into the content of the container, thereby permitting interaction between the flavoring substance 16 and the contents of the container 36 prior to consumption. The user can of course consume only the flavoring substance 16 and not the contents of the container 36. Alternatively, the user can consume only the contents of the container 36 and not the flavoring substance 16.

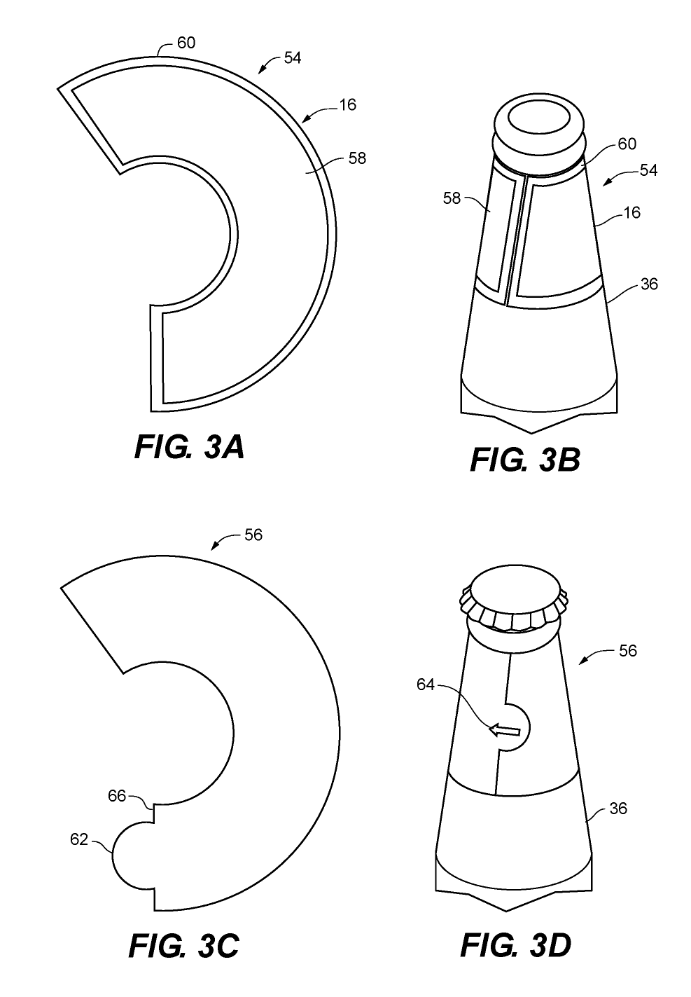

FIG. 3A illustrates a non-limiting exemplary embodiment of another label 54 configured for being disposed, as illustrated in FIG. 3B, about the neck of the container 36. FIG. 3C illustrates a non-limiting exemplary embodiment of another pull-tab 56 configured for use with the label 54, and FIG. 3D illustrates the pull-tab 56 covering the entirety of the flavoring substance 16 while being removably engaged with the label 54. In some embodiments, several aspects of the label 54 are similar to those of the label 10, and several aspects of the pull-tab 56 are similar to those of the pull-tab 20. One illustrated difference between the labels 10 and 54 is in the disposition of the flavoring substance 16 on their respective first surfaces 12 and 58. In certain embodiments, a band 60 along at least a portion of the perimeter of the first surface 58 is devoid of the flavoring substance 16. As such, the band 60 on the first surface 58 of the label 54 and at least a portion of the pull-tab 56 are configured for removable engagement with each other along at least a portion of their respective perimeters. In some embodiments, at least a portion of the band 60 that gets overlapped by the pull-tab 56 is tacky. In certain embodiments, at least a portion of the perimeter of the pull-tab 56 that will be overlapping the band 60 is tacky. In some embodiments, at least a portion of the band 60 overlapped by the pull-tab 56 and at least a portion of the pull-tab 56 overlapping the band 60 are tacky. As such, the pull-tab 56 can be positioned over the label 54 to cover the entirety of the flavoring substance 16, and the label 54 and the pull-tab 56 removably engaged with other along at least a portion of their respective perimeters as illustrated in FIG. 3D. Subsequently, the user can expose at least a portion of the flavoring substance 16 by displacing the tab 62 of the pull-tab 56 in the direction indicated by the arrow 64.

As with the pull-tab 20, certain embodiments of the pull-tab 56 may not include the tab 62. In some such embodiments, at least a portion of the perimeter along an edge 66 of the pull-tab 56 is not removably engaged with the label 54. In such embodiments, the user can grasp at least a portion of the perimeter along the edge 66 and displace it in the direction indicated by the arrow 64 to expose at least a portion of the flavoring substance 16 disposed on the label 54.

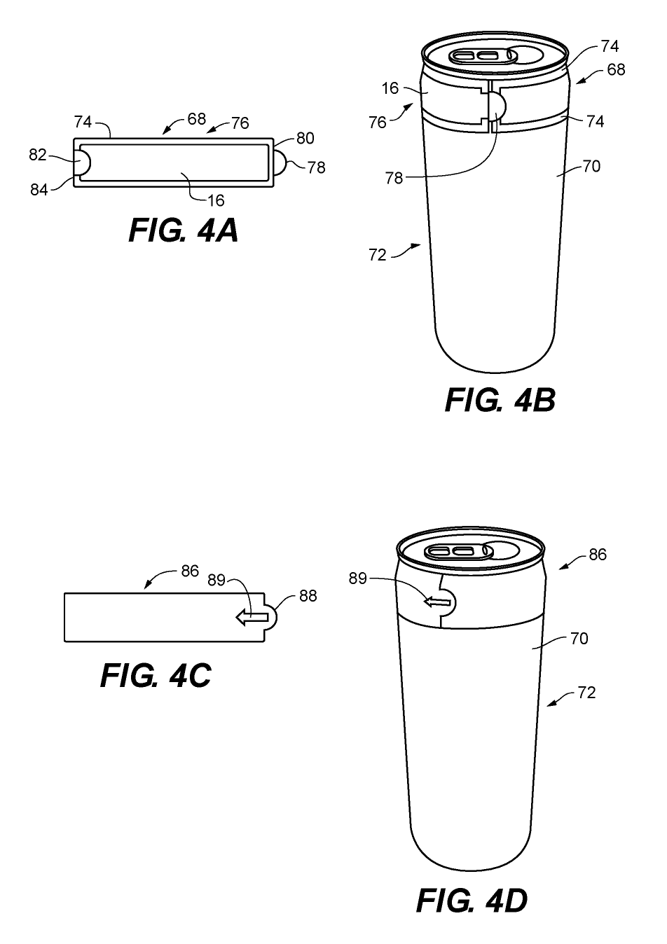

As can be seen, the labels 10 and 56 are configured for forming a conical wrap such as for the neck of a bottle. FIG. 4A illustrates a non-limiting exemplary embodiment of yet another label 68, and FIG. 4B illustrates the label 68 disposed on an exterior surface 70 of a container 72. As with the label 54, the label 68 includes a band 74, devoid of the flavoring substance 16, along the perimeter of a first surface 76. In some embodiments, the label 68 includes a tab 78 extending outwardly from an edge 80, and an additional section 82 proximate an edge 84 that is also devoid of the flavoring substance 16. In certain embodiments, at least a portion of the tab 78 overlaps at least a portion of the section 82 when the label 68 is wrapped around the exterior surface 70 of the container 72 as illustrated in FIG. 4B. In some embodiments, the tab 78 and the section 82 are configured for engagement with other. In certain embodiments, at least a portion of the surface of the tab 78 overlapping at least a portion of the section 82 includes a tacky substance or an adhesive for engagement with the section 82. In some embodiments, at least a portion of the surface of the section 82 overlapped by the tab 78 includes a tacky substance or an adhesive for engagement with the tab 78. In certain embodiments, both the portion of the tab 78 overlapping the section 82 and the portion of the section 82 overlapped by the tab 78 include a tacky substance or an adhesive for engaging the tab 78 and the section 82 with each other. In some embodiments, the second surface of the label 68 opposite the first surface 76 having the flavoring substance 16 includes an adhesive or similar substance disposed on at least a portion thereof for affixing the label 68 on the container 72. In certain embodiments, the second surface of the label 68 is configured for being affixed to the exterior surface 70 of the container 72 without an adhesive or similar substance. Additionally or in the alternative, some embodiments of the label 68 may be composed of a heat shrink material.

FIG. 4C illustrates a non-liming exemplary embodiment of a pull-tab 86 configured for, as illustrated in FIG. 4D, covering the entirety of the flavoring substance 16 and removable engagement with the label 68 disposed on the container 72. In some embodiments, several aspects of the pull-tab 86 are similar to those of the pull-tab 56. As such, the label 68 and the pull-tab 86 are removably engaged and dis-engaged in substantially the same manner as the label 54 and the pull-tab 56. As shown, the pull-tab 86 includes a tab 88 which is pulled in the direction indicated by the arrow 89 for dis-engaging the label 68 and the pull-tab 86 from each other.

Several non-limiting exemplary methods can be used for providing a container with a flavor enhancement system similar to those illustrated and described. For instance, in some embodiments, the flavoring substance is first disposed on the first surface of the label. Then a pull-tab is positioned to cover the entirety of the flavoring substance and removably engaged with the label. Next, an adhesive or a tacky or a sticky substance is disposed on the second surface of the label, i.e., the surface opposite the surface having the flavoring system. Then, in some exemplary embodiments, the label, and more specifically the second surface of the label, is affixed to an exterior surface of the container. In some alternative exemplary embodiments, the entirety of the second surface, and more specifically the substance disposed on the second surface, is covered with a removable strip which is removed by the user before affixing the label to a container. One or more such labels are then placed in a sealed or an un-sealed pouch or sleeve. In some embodiments, all of the one or more labels placed in the pouch/sleeve have the same flavoring substance. In certain embodiments, each of the one or more labels placed in the pouch/sleeve has a different flavoring substance. In some embodiments, the flavoring substance of the one or more labels placed in the pouch/sleeve is randomly selected during packaging. In certain embodiments, the pouch or sleeve containing the one or more labels is coupled with a container and sold/purchased as a single or an integral unit or component. In some embodiments, the pouch or sleeve containing the one or more labels is selected by the consumer separately from the container. In certain embodiments where the label is not pre-attached to the container and is available as a separate component or unit, the user has the option of not affixing the label on the container. Irrespective of whether the label is pre-attached to the container or where the user has the option of attaching the label to the container, at least a portion of the flavoring substance is exposed when the user dis-engages at least a portion of the pull-tab from the label.

In certain embodiments, a label, without the flavoring substance disposed thereon, is first affixed to a container. Next, a flavoring substance is disposed on the exposed surface of the label. Then, a pull-tab is positioned to cover the entirety of the flavoring substance and the pull-tab is removably engaged with the label. During use, at least a portion of the flavoring substance is exposed when the user dis-engages at least a portion of the pull-tab from the label.

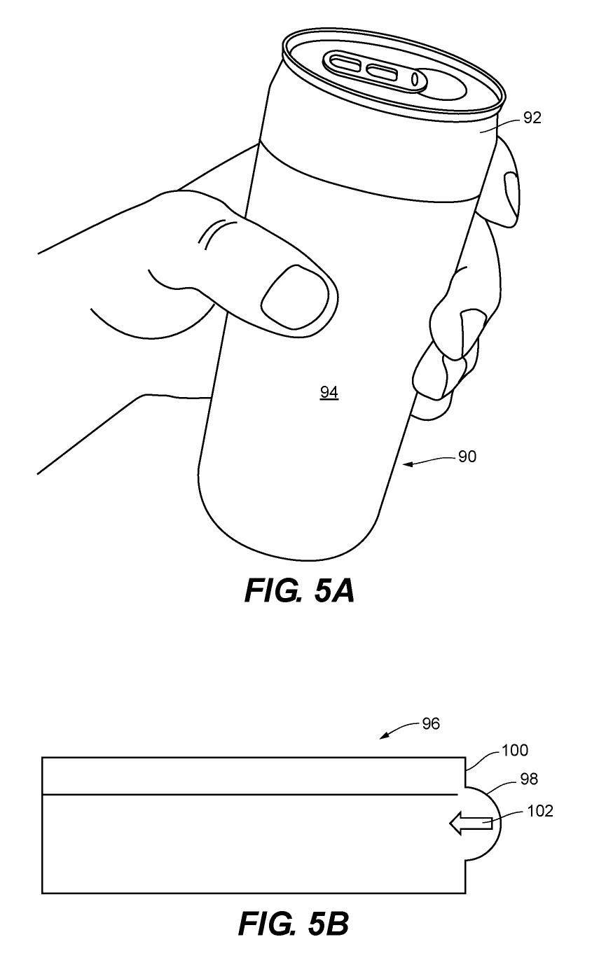

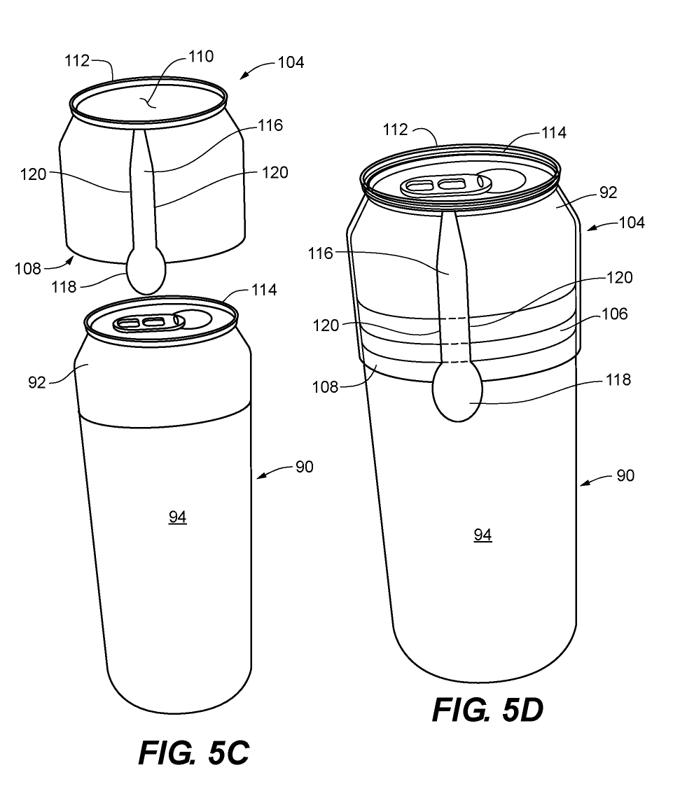

FIG. 5A is a perspective view of a non-limiting exemplary embodiment of a container 90 having a composition 92 disposed on an exterior surface 94 thereof. In some embodiments, the composition 92 is the flavoring substance 16. In certain embodiments, the composition 92 is an emulsion composed of the flavoring substance 16 and an edible adhesive or similar substance. In some embodiments, the composition 92 is composed of one or more granular flavoring substances and an edible adhesive. FIG. 5B is an elevational view of a non-limiting exemplary embodiment of a pull-tab 96 configured for covering the entirety of the composition 92 disposed on the exterior surface 94 of the container 90. In some embodiments, the pull-tab 96 includes a tab 98 extending away from an edge 100 of the pull-tab 96. In certain embodiments, the tab 98 does not extend away from the pull-tab 96, but rather overlaps the pull-tab 96. At least a portion of the composition 92 is exposed when the user grasps the tab 96 and pulls it in the direction indicated by the arrow 102.

FIG. 5C is a perspective view of a non-limiting exemplary embodiment of a sleeve 104 for use with the container 90. In some embodiments, the sleeve 104 is slid onto the container 90 for covering the entirety of the composition 92. In certain embodiments, such as the non-limiting exemplary embodiment illustrated in FIG. 5D, the sleeve 104 is at least partially longer or wider than the length or width of the composition 92 disposed on the exterior surface 94 of the container 90. In some embodiments, a tacky band 106 is provided for removably engaging at least a bottom portion 108 of the sleeve 104 and the exterior surface 94 with each other. In certain embodiments, at least a portion of the tacky band 106 is disposed along at least a portion of an inside surface 110 of the sleeve 104. In some embodiments, at least a portion of the tacky band 106 is disposed along at least a portion of the exterior surface 94 of the container 90. In certain embodiments, at least a portion of the tacky band 106 is disposed along at least a portion of the inside surface 110 of the sleeve 104 and along at least a portion of the exterior surface 94 of the container 90. In some embodiments, an adhesive or similar substance is disposed on at least a portion of the inside surface 110 and/or at least a portion of the exterior surface 94 for removably affixing the sleeve 104 to the container 90.

In some embodiments, a top 112 of the sleeve 104 is configured to extend at least partially above a top 114 of the container 90. In certain embodiments, the tops 112 and 114 are configured to substantially align with each other without exposing any portion of the composition 92. In some embodiments, the top 112 extends slightly below the top 114 though not exposing any portion of the composition 92. In certain embodiments, at least a portion of the top 112 and at least a portion of the top 114 are removably engaged with each other. In some embodiment at least a portion of the top 112 and at least a portion of the sleeve 104 proximate the top 114 are removably engaged with each other.

In a non-limiting exemplary embodiment, the sleeve 104 includes a removable or dis-engageable strip 116 having a tab 118. In some embodiments, the sleeve 104 has one or more perforations, for example along one or both lines 120, for removing the strip 116. In certain embodiments, the one or more lines 120 are scored or configured for easing or aiding in the removal of the strip 116. In some embodiments, a thickness of the material along the one or more lines 120 is relatively less than a thickness of the sleeve 104 and/or a thickness of the strip 116. In use, pulling on the tab 118 will separate or disconnect at least a portion of the sleeve 104 and at least a portion of the strip 116 from each other. The sleeve 104 is then removed to expose at least a portion of the composition 92.

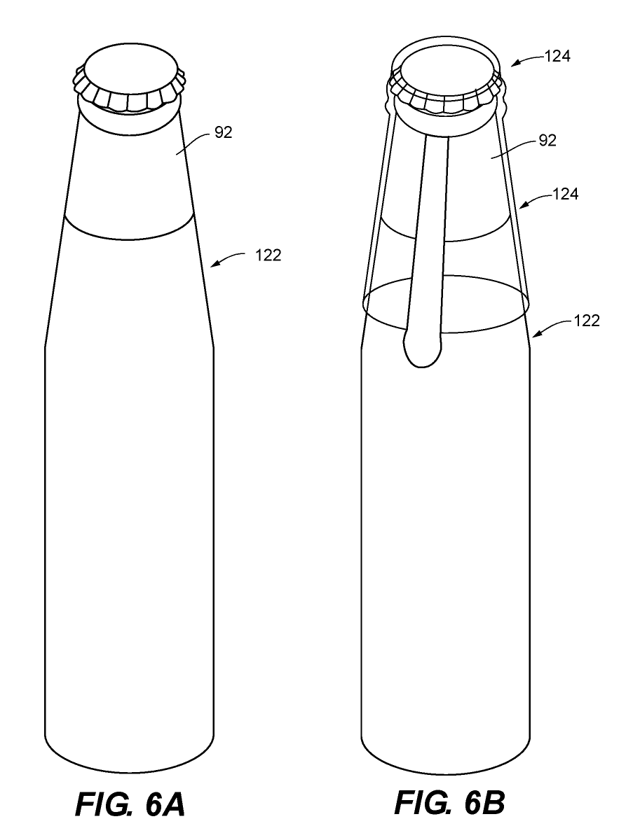

FIG. 6A is a perspective view of a non-limiting exemplary embodiment of a container 122, e.g., a bottle, having a composition 92 disposed on an exterior surface thereof. FIG. 6B is a non-limiting exemplary embodiment of a sleeve 124 configured for covering the entirety of the composition 92 disposed on the exterior surface of the container 122. In some embodiments, several aspects of the sleeve 124 are similar to those of the sleeve 104.

In certain embodiments, one or both sleeves 104 and 124 are composed of a heat shrink material configured to engage their respective containers 90 and 122 at the desired location. In some embodiments, one or both sleeves 104 and 124 are composed of an elastic material such that the void circumscribed by the sleeve can be enlarged or stretched for positioning the sleeve about the corresponding container for engagement therewith. In certain embodiments, it may not be necessary to provide an adhesive or a similar substance on the inside surface of the sleeve and/or on the exterior surface of the container. The disclosed configurations and/or functionalities of the sleeves 104 and 124 should not be construed as limiting. Alternative and/or additional embodiments may become apparent to a person of ordinary skill. Accordingly, all variations are considered as being within the metes and bounds of the instant disclosure.

In some non-limiting exemplary embodiments, the contents of the one or more containers 36, 72, 90, and 122, i.e., the consumable, is a beverage. In certain non-limiting exemplary embodiments, the flavoring substance 16 includes one or more of salts, spices, citrus flavors, fruit flavors, and desert flavors. In some non-limiting exemplary embodiments, the composition 92 includes one or more of salts, spices, citrus flavors, fruit flavors, and desert flavors.

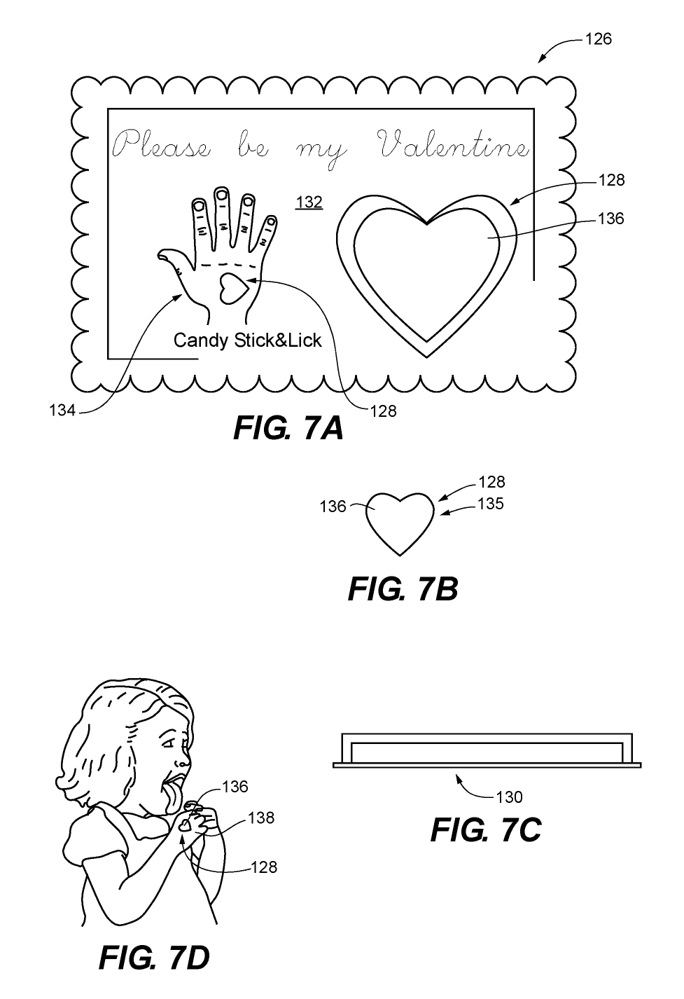

FIGS. 7A-7C illustrate a non-limiting exemplary embodiment of a novelty item 126. In some embodiments, the novelty item 126 is a valentine card having a heart-shaped label 128 and a candy stick 130. In certain embodiments, one or both the heart-shaped label 128 and the candy stick 130 are removably affixed on the face (or front) 132 and/or on the rear of the novelty item 126. In some embodiments, the novelty item 126 includes an illustration 134 or instructions for using the label 128. As with the labels 10 and 68, a non-limiting exemplary embodiment of the label 128 includes a first or front surface 135 and a rear or second surface (not illustrated) opposite the front surface 135. In some embodiments, a flavoring substance 136 is disposed on at least a portion of the front surface 135 of the label 128, and the rear surface of the label 128 is configured for removable engagement with a skin 138 of a user's hand. FIG. 7D is a non-limiting exemplary embodiment illustrating the use of the label 128 and the candy stick 130. As shown, in certain embodiments, the rear surface of the label 128 is attached to the skin 138, and the user is holding the candy stick 130 in the hand. The user than consumes the candy stick 130 and/or the flavoring substance 136 by, for instance, licking it. In a non-limiting exemplary embodiment, the entirety of the label 128 is composed of one or more edible substances or items.

In some embodiments, the entire novelty item 126 is disposed inside a sealed or unsealed pouch or sleeve. Additionally, or in the alternative, the label 128 and/or the candy stick 130 are disposed inside a sealed or unsealed pouch or sleeve either separately or together.

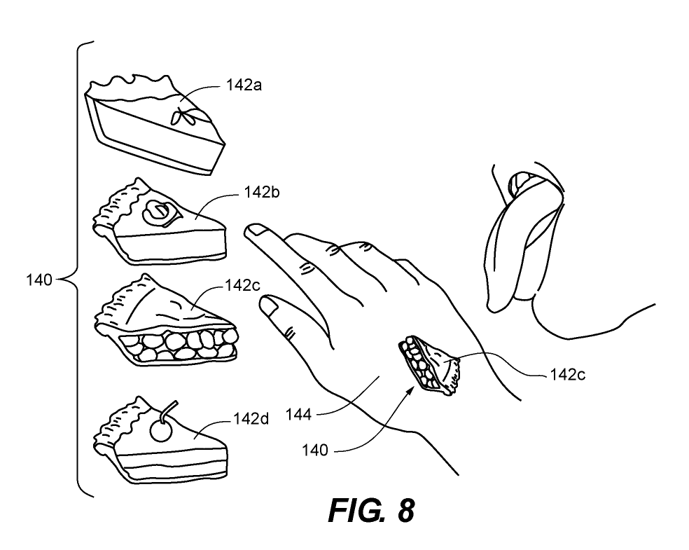

FIG. 8 is a non-limiting exemplary embodiment of a plurality of labels 140 configured with different flavoring substances 142a, 142b, 142c, and 142d disposed on a front (or first) surface of their respective labels 140. As with the label 128, the labels 140 are configured for engagement with a skin 144 of the user. In a non-limiting exemplary embodiment, the user affixes the label 140 having the desired flavoring substance 142a-142d onto the skin 144. The user is then able to “taste” the selected flavoring substance, for instance, by licking the front (or first) surface of the label 140.

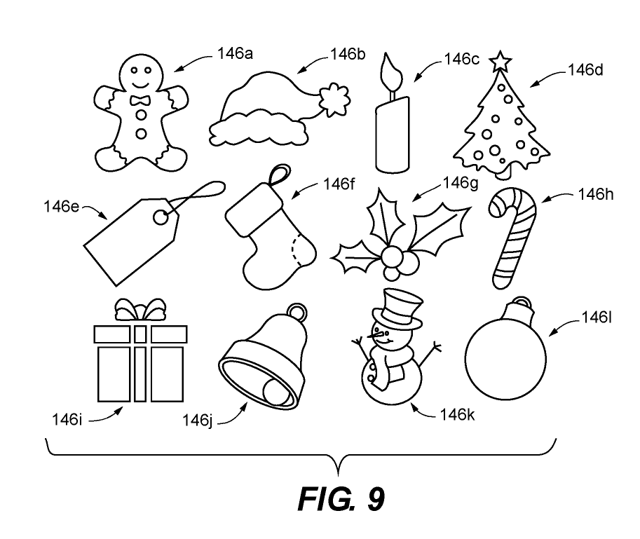

FIG. 9 illustrates non-limiting exemplary embodiments of a plurality of labels 146a-1461 having one or more festival-specific flavoring substance disposed thereon. In some embodiments, several aspects of the one or more of the labels 146a-1461 are similar to one or more of the labels 10, 54, 68, 128, and 142a-142d. In certain embodiments, the first or front surface of the labels 146a-1461 includes one or more flavoring substances disposed thereon, and the second or rear surface is configured for engagement with the skin of the user. The labels 146a-1461 illustrated in FIG. 9 are of different shapes, colors, sizes, etc., configured for use or exchange around Christmas. However, the illustrated configurations should not be construed as limiting. For instance, additional or alternative configurations, such as Santa Clause, reindeer, snowflakes, etc. may also be provided for use or exchange during Christmas. In some embodiments, each label may have more than one flavoring substance disposed thereon. For instance, the white areas of the gingerbread man illustrated in FIG. 146a may be flavored as an icing, and the remaining portion may have a ginger flavor. In certain embodiments, the labels may be configured as one or more of a clover leaf, a leprechaun, a pot of gold, etc., for exchange around St. Patrick's Day. As with the label 128 illustrated in FIG. 7A-7D, the labels 146a-1461 may be disposed inside a sealed or unsealed pouch or sleeve. Additionally or in the alternative, some embodiments of the labels 146a-1461 may be one or more of a candy or a cookie or other confectionary item. Various additional and/or alternative concepts and configurations, as may become apparent to one of ordinary skill, are considered as being within the metes and bounds of the instant disclosure.

In view thereof, modified and/or alternate configurations of the embodiments described herein may become apparent or obvious to one of ordinary skill. All such variations are considered as being within the metes and bounds of the instant disclosure. For instance, while reference may have been made to particular feature(s) and/or function(s), the disclosure is considered to also include embodiments configured for functioning and/or providing functionalities similar to those disclosed herein with reference to the accompanying drawings. Accordingly, the spirit, scope and intent of the instant disclosure is to embrace all such variations. Consequently, the metes and bounds of the disclosure is solely defined by the appended claims and any and all equivalents thereof.

What is claimed is:

1. A system for enhancing the flavor of a consumable, the system comprising:
a label comprising opposing first and second surfaces;
a flavoring substance disposed on at least a portion of the first surface;
a first pull-tab removably affixed to the first surface of the label and covering the flavoring substance in its entirety; and
an adhesive on at least a portion of the second surface.

2. The system of claim 1, wherein the adhesive is adapted to fixedly secure the second surface of the label to at least a portion of one of an outside surface of a container of the consumable and a skin.

3. The system of claim 2, comprising a second pull-tab removably affixed to the second surface of the label and covering the adhesive in its entirety.

4. The system of claim 1, wherein the flavoring substance comprises one or more of salts, spices, citrus flavors, fruit flavors, and desert flavors.

5. The system of claim 1, wherein the flavoring substance comprises one or more of a liquid and a solid.

6. The system of claim 1, wherein the first pull-tab is water-proof and tamper-proof.

7. The system of claim 1, wherein both the label and the first pull-tab are elastic.

8. The system of claim 7, wherein the second surface is devoid of the adhesive and is configured for grasping at least a portion of an outside surface of a container of the consumable.

9. The system of claim 1, wherein the second surface is devoid of the adhesive and the label is composed of a heat-shrink material

10. A system for enhancing the flavor of a consumable, the system comprising:
an adhesive disposed on at least a portion of an outside surface of a container of the consumable;
a flavoring substance disposed on at least a portion of the adhesive; and
a pull-tab removably affixed to the outside surface of the container and covering the flavoring substance in its entirety.

11. The system of claim 10, wherein the adhesive is composed of an edible substance.

12. The system of claim 10, wherein the flavoring substance comprises one or more of salts, spices, citrus flavors, fruit flavors, and desert flavors.

13. The system of claim 10, wherein the flavoring substance comprises one of a liquid, a solid, or a combination of a liquid and a solid.

14. The system of claim 10, wherein the pull-tab is water-proof and tamper-proof.

15. A system for enhancing the flavor of a consumable, the system comprising:
an emulsion disposed on at least a portion of an outside surface of a container of the consumable; and
a pull-tab removably affixed to the outside surface of the container and covering the emulsion in its entirety.

16. The system of claim 15, wherein the emulsion comprises
a flavoring substance; and
an adhesive composed of an edible substance.

17. The system of claim 15, wherein the emulsion comprises one or more of salts, spices, citrus flavors, fruit flavors, and desert flavors.

18. The system of claim 15, wherein the pull-tab is water-proof and tamper-proof.
